(19) United States
(12) Patent Application Publication
(10) Pub. No.: US 2007/0296847 A1
(43) Pub. Date: Dec. 27, 2007

(54) METHOD OF MAKING IMAGE CAPTURE UNIT

(76) Inventors: Chao-Chi CHANG, Taipei City (TW); Yung-I Chen, Taipei City (TW); Jean-Pierre Lusinchi, Taipei City (TW)

Correspondence Address: SINORICA, LLC, 528 FALLSGROVE DRIVE, ROCKVILLE, MD, 20850, US

(21) Appl. No.: 11/774,646

(22) Filed: Jul. 9, 2007

(30) Foreign Application Priority Data
Jun. 21, 2006 (TW) 96122374

(51) Int. Cl. H04N 5/225

(52) U.S. Cl. 348/340

(57) ABSTRACT

The present invention provides a method of making an image capture unit, which includes the steps of: providing an image sensor; attaching a plate on the image sensor; providing at least one cavity on the plate aligned with the image sensor; mounting lenses in the cavity of the plate, and attaching a cover on the plate to shield a margin region of each of the lenses.

### BACKGROUND OF THE INVENTION

1. Field of the Invention

The present invention relates generally to an optical lens, and more particularly to a method of making an image capture unit.

2. Description of the Related Art

Typically, a conventional image capture unit includes an image sensor and an optical lens attached on the image sensor. The optical lens includes a holder, a barrel on the holder and one or more lenses mounted in the barrel. Typically, the barrel and the holder are made of plastic by injection molding that advantages mass production. As the requirement of decreasing the size of the image capture unit becomes more important, the size of all the optical elements must also decrease,but the barrel and the holder made by injection molding can not have the necessary precision in size. In addition, an image receiving side of the image sensor is very sensitive and any fine dust on the image receiving side may cause a mark on the image. In the conventional method of attaching the optical lens on the image sensor, there are always dusts falling on the image sensor in the attaching process that causes a defective product.

The conventional way of making the image capture units is attaching the optical lenses on the individual image sensor one by one that is a long process and expensive process.

### SUMMARY OF THE INVENTION

The primary objective of the present invention is to provide a method of making an image capture unit, which keeps the image sensor and lens clean to prevent dust on the image sensor.

The secondary objective of the present invention is to provide a method of making an image capture unit, which increases the precision in size of the optical lens.

The further objective of the present invention is to provide a method of making an image capture unit, which has a lower cost of manufacture.

According to the objectives of the present invention, a method of the present invention includes the steps of: providing an image sensor; attaching a plate on the image sensor; providing at least one cavity on the plate aligned with the image sensor; mounting lenses in the cavity of the plate, and attaching a cover on the plate to shield a margin region of each of the lenses.

The method of the present invention further includes the step of forming a planarization cover on the image sensor before the step of attaching the plate on the image sensor, wherein the plate is attached on the planarization cover.

The method of the present invention further includes the step of coating an antireflective coating on a sidewall of the cavity of the plate before the step of mounting the lenses in the cavity.

Another method of the present invention includes the steps of: providing a plate with at least one cavity; mounting lenses in the cavity of the plate; attaching a cover on the plate to shield a margin region of each of the lenses; and attaching the plate on an image sensor.

### BRIEF DESCRIPTION OF THE DRAWINGS

FIG. 1 is a flow chart of a first preferred embodiment of the present invention;

FIG. 2 is a sectional view of assembling the products of the first preferred embodiment of the present invention; and

FIG. 3 is a flow chart of a second preferred embodiment of the present invention.

### DETAILED DESCRIPTION OF THE INVENTION

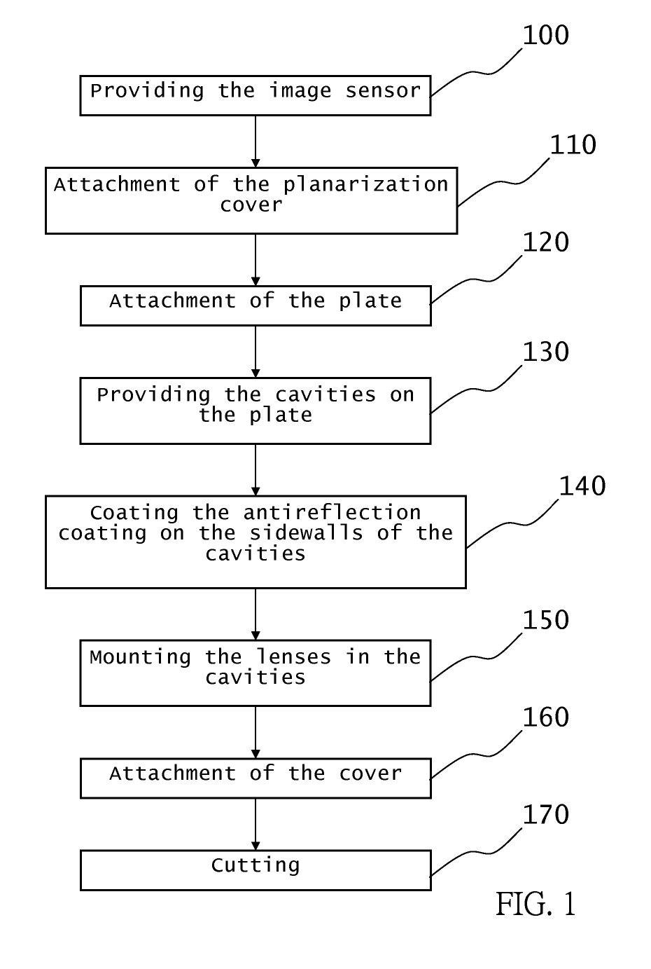

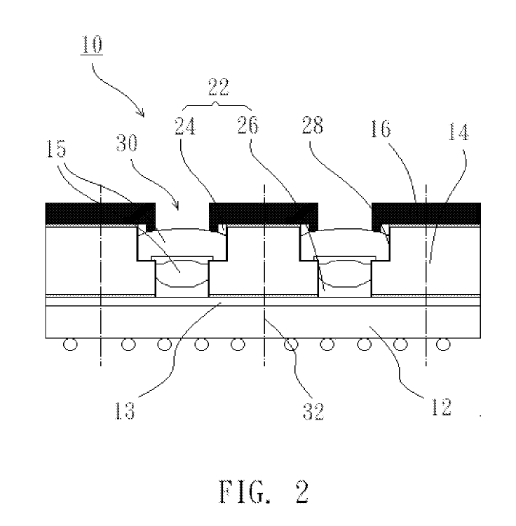

As shown in FIG. 1 and FIG. 2, a method of making an image capture unit 10 of the first preferred embodiment of the present invention includes the following steps:

The first step 100 is providing an image sensor 12. The image sensor 12 is a conventional CMOS or CCD sensor, which may have single sensing chip or multi sensing chips arranged in array (such as 2*2 or 2*3 array). In the present invention, the image sensor 12 may have a plurality of sensing chips arranged in array.

The second step 110 is attachment of a planarization cover 13. The planarization cover 13, which may be silicon oxide, silicon nitride, glass or other transparent materials, is provided on the image sensor 12 by the conventional planarization method. The planarization cover 13 may isolate moisture and dirt from the image sensor 12, and may act like an infrared radiation filter also to filter or select infrared radiation.

The third step 120 is attachment of plate 14. The plate 14, which is made of monocrystalline silicon, is attached on the planarization cover 13 by an adhesive (such as resin).

The fourth step 130 is providing cavities 22. This step incorporates the conventional semiconductor processes including masking, dry or wet etching to form a plurality of the cavities 22 on the plate 14 to unshield portions of the planarization cover 13. Each of the cavities 22 may have two sections 24 and 26 with different diameters.

The fifth step 140 is coating an antireflective coating 28 on a sidewall of each cavity 22.

The sixth step 150 is mounting lenses 15. Two lenses 15 are mounted in the sections 24 and 26 of each cavity 22 respectively and are fixed and tested by conventional methods. The lenses 15 are made of glass and made by molding. The glass lenses are more stable in high temperature environment than plastic lenses.

The seventh step 160 is attachment of a cover 16. The cover 16, which is made of opaque black plastic, attached on the plate 14 by an adhesive. The cover 16 has a plurality of openings 30 aligned with the cavities 22 of the plate 14. Diameters of the openings 30 of the cover 16 are smaller than that of the cavities 22 of the plate 14 that a margin region of each of the lenses15 is shielded by the cover 16. Radiation may reach the image sensor 12 through the openings 30 and the lenses 15.

The last step 170 is division. Conventional cutting process, such as mechanical cutting or laser cutting, is incorporated to cut the cover 16, the plate 14, the planarization cover 13 and the image sensor 12 along lines 32 shown in FIG. 1 to get a plurality of image capture units.

The present invention provides the plate 14 on the image sensor 12 and the plate 14 having the cavities 22 aligned with the sensing chips of the sensor 12 that the cover 16, the plate 14, the planarization cover 13 and the image sensor 12 are separated to form a plurality of image capture units. The method of the present invention has advantages of simple process, lower cost of manufacture, high precision in size and dustproof of the sensor 12 that may decrease the defective ratio of the products.

In the step of attachment of the plate, the plate may inherently have the openings and had been coated with the antireflective coating and mounted with the lenses for performance of the following steps directly.

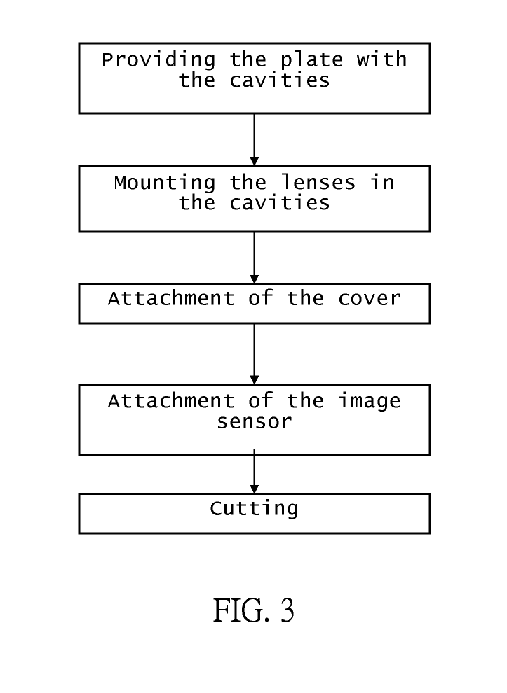

FIG. 3 shows a flow chart of a method of the second preferred embodiment of the present invention, which is similar to the method of the first preferred embodiment. The different steps include providing a plate inertly having cavities to be attached on a planarization cover. The following steps includes mounting lenses and attachment of a cover as same as the first preferred embodiment, and then the plate is attached on an image sensor for separation to get a plurality of image capture units.

In conclusion, the method of the present invention provides the image sensor with a plurality of sensing chips shielded by the plate with a plurality of optical lenses. The method of the present invention has a simple process, lower cost of manufacture. The method of the present invention reduces the risk of contamination of the image sensor by dust, and then has a lower defectivity rate, while increasing the precision in the dimensions of the optical elements.

The description above is a few preferred embodiments of the present invention and the equivalence of the present invention is still in the scope of the claim of the present invention.

What is claimed is:

1. A method, comprising the steps of:
providing an image sensor;
attaching a plate on the image sensor;
providing at least one cavity on the plate aligned with the image sensor;
mounting lenses in the cavity of the plate;
attaching a cover on the plate to shield a margin region of each of the lenses.

2. The method as defined in claim 1, further comprising the step of forming a planarization cover on the image sensor before the step of attaching the plate on the image sensor, wherein the plate is attached on the planarization cover.

3. The method as defined in claim 1, further comprising the step of coating an antireflective coating on a sidewall of the cavities of the plate before the step of mounting the lenses in the cavity.

4. The method as defined in claim 1, wherein the image sensor is a CMOS or CCD sensor.

5. The method as defined in claim 2, wherein the planarization cover is made of glass, silicon oxide or silicon nitride.

6. The method as defined in claim 2, wherein the plate is attached on the planarization cover by an adhesive.

7. The method as defined in claim 1, wherein it includes masking and dry or wet etching in the step of providing the cavity on the plate.

8. The method as defined in claim 7, wherein the plate is made of silicon.

9. The method as defined in claim 4, wherein the image sensor may have one sensing chip or a plurality of sensing chips arranged in array, and the plate has at least one of the cavity aligned with each sensing chip.

10. The method as defined in claim 9, further comprising the step of cutting the cover, the plate and the image sensor to get a plurality of image capture units after the step of attaching the cover.

11. The method as defined in claim 10, wherein the step includes mechanical cutting process or laser cutting process.

12. The method as defined in claim 1, wherein the cover, which is made of opaque black plastic, is attached on the plate by an adhesive.

13. The method as defined in claim 1, wherein each of the cavities of the plate has sections with different diameters.

14. The method as defined in claim 1, wherein the lenses are mounted in each of the sections of the cavities of the plate.

15. A method, comprising the steps of:
providing a plate with at least one cavity;
mounting lenses in the cavity of the plate;
attaching a cover on the plate to shield a margin region of each of the lenses; and
attaching the plate on an image sensor.

16. The method as defined in claim 1, wherein the plate is attached on a planarization cover.

17. The method as defined in claim 15, wherein the planarization cover is made of glass, silicon oxide or silicon nitride.

18. The method as defined in claim 15, wherein the image sensor may have one sensing chip or a plurality of sensing chips arranged in array, and the plate has at least one of the cavities aligned with each sensing chip.

19. The method as defined in claim 18, further comprising the step of cutting the cover, the plate and the image sensor to get a plurality of image capture units after the step of attaching the cover.

20. The method as defined in claim 1, wherein the lenses are made of glass.

21. The method as defined in claim 15, wherein the lenses are made of glass.
